(19) United States
(12) Patent Application Publication
(10) Pub. No.: US 2002/0138171 A1
(43) Pub. Date: Sep. 26, 2002

(54) Numerical control method and numerically controlled allaratus

(76) Inventor: Mutoshi Fukutani, Tokyo (JP)

Correspondence Address: SUGHRUE MION, PLLC, 2100 PENNSYLVANIA AVENUE, N.W., WASHINGTON, DC, 20037, US

(21) Appl. No.: 10/088,137

(22) PCT Filed: Feb. 22, 2001
(86) PCT No.: PCT/JP01/01302

(51) Int. Cl. G06F 19/00

(52) U.S. Cl. 700/188; 700/159

(57) ABSTRACT

In a numerically controlled apparatus having a peripheral speed uniforming control function, by performing a peripheral speed uniforming control only on coordinates of a start point of feed for cutting except for a non-cutting block, consumption of power wasted by executing the peripheral speed uniforming control on the non-cutting block is reduced.

### TECHNICAL FIELD

The present invention relates to a numerical control method and a numerically controlled apparatus and, more particularly, reduction in power consumption associated with revolution of a main spindle.

### BACKGROUND ART

In the case of attaching a workpiece to the main spindle of a lathe or the like and lathe-turning the workpiece, as a tool moves toward the center portion of the workpiece, the peripheral speed of a tool contact portion decreases. It causes a problem such that the cutting accuracy of the workpiece deteriorates and tool life is shortened. Consequently, a control of making the peripheral speed constant is generally performed so that the relative speed between the workpiece and the tool contact portion becomes constant, thereby preventing deterioration in cutting accuracy due to inaccurate cutting positions and increasing the tool life.

Generally, in a lathe, the reference axis of a peripheral speed uniforming control is an X axis. As the X axis approaches the center of a workpiece attached to the main spindle, the spindle speed of the main spindle is increased.

The main spindle speed (min⁻¹) at the time of the peripheral speed uniforming control is calculated by the following.

(1000×S)/(2×π×X) (equation 1)

where S denotes peripheral speed (m/min) and X indicates a program coordinate value (value from the center of the workpiece) (mm) of a peripheral speed uniforming reference axis.

FIG. 12 is a block diagram showing the configuration of a numerically controlled apparatus having a conventional peripheral speed uniforming control function.

Specifically, in the diagram, 101 denotes a program analyzing unit which reads a machining program block by block, analyzes a shift amount, speed, and the like in accordance with a G code or the like, and generates block information. Block information includes modal information, a shift amount of each axis, main spindle and auxiliary instruction data such as an S instruction and an M instruction, and the like. 102 denotes an interpolating unit which distributes the shift amount to each axis in accordance with the block information generated by the program analyzing unit 101, 103 indicates an accelerating/decelerating unit which performs an accelerating/decelerating process with a predetermined time constant on the shift amount distributed to each of the axes, and 104 expresses a position data outputting unit which outputs a position instruction of acceleration/deceleration to a servo amplifier.

105 indicates a peripheral speed uniforming computing unit which computes the main spindle speed so that the peripheral speed becomes constant on the basis of the interpolated position information of the reference axis, and 106 denotes a speed data outputting unit which outputs a main spindle speed instruction computed by the peripheral speed uniforming computing unit 105 to a main spindle amplifier.

The peripheral speed uniforming computing unit 105 sequentially computes the speed of the main spindle in accordance with coordinates (radius) of the reference axis during feed for cutting and computes the speed of the main spindle on the basis of coordinates of the end point of the block during fast feed.

In an instruction in the machining program, generally, the peripheral speed uniforming control is made valid by G96 and canceled by G97.

In the case of performing the peripheral speed uniforming control, for example, a machining program as described below is used. For the following description, the machining program will be called a machining program A.

In the example, the X axis is used as a reference axis of the peripheral speed uniforming computation. The machining operation and the speed of the main axis are as shown in FIG. 13.

N001 G30 X0. Z0.; . . . return to tool replacement position

N002 T01 S300 M03; . . . selection of tool, revolution of spindle shaft

N003 G92 X100. Z-200.; . . . preset the center of workpiece to “0”

N004 G96 S200; . . . start the peripheral speed uniforming control at peripheral speed of 200 m/min (318 min⁻¹)

N005 G00 X50. Z-160.; . . . positioning

N006 X30. Z-110.;

N007 G01 Z-90. F2000; . . . cutting N008 X10. Z-60.;

N009 Z-50.;

N010 X30. Z-30.;

Specifically, in the N004 block, the main spindle revolves at the peripheral speed of 200 m/min and the speed of the main spindle at this time is 318 min⁻¹.

Since the N005 block relates to a fast feed instruction, the peripheral speed at the end point of the instruction is calculated. The peripheral speed uniforming computation is therefore executed so that the peripheral speed in the position of 50 mm of the X-axis coordinate becomes 200 m/min instructed by the machining program and, as a result, the main spindle speed becomes 637 min⁻¹.

Then the main spindle is accelerated according to the response to the speed loop of the main spindle from 318 min⁻¹ to 637 min⁻¹.

Like the N005 block, the N006 block also relates to the fast feed instruction. The peripheral speed constant computation is therefore performed in the position of 30 mm of the X-axis coordinate, and the speed of the main spindle becomes 1,061 min⁻¹.

In the N008 block, the peripheral speed uniforming computation is sequentially performed while the value shits on the X axis, and the speed in the position of 10 mm of the end point coordinate becomes 3,183 min⁻¹.

In the N009 block, there is no change in the X-axis coordinate. Consequently, the main spindle speed is held as it is. In the N010 block, as the value on the X axis moves to the position of 30 mm, the main spindle speed decreases to 1,061 min⁻¹.

In the conventional technique, however, when the peripheral speed uniforming instruction (G96) is given in the machining program, the peripheral speed uniforming control is immediately started. Also in the blocks (such as N004 and N005 blocks) other than the block of feed for cutting, in which the peripheral speed actually has to be made constant, the peripheral speed uniforming computation is executed. As a result, the main spindle is unnecessarily accelerated or decelerated and the power is consumed.

For example, in the case of performing a process of opening a plurality of holes positioned at predetermined intervals, the process is performed by using a machining program as flows. For the following description, the machining program will be called a machining program B.

N0401 G91 G30 X0. Y0. Z0.; . . . return to tool replacement position

N0402 T04 M06; . . . replacement of tool

N0403 G90 G54 G00 X60. Y250. S1500 M3; . . . positioning, revolution of main spindle

N0404 G43 Z300. H04; . . . correction of tool length N0405 Z230.;

N0406 G01 Z210. F150; . . . drilling (feed for cutting)

N0407 GOO Z300.;

N0408 X-70. Y200.; . . . positioning to next hole position

N0409 Z230.;

N0410 G01 Z210. F300; . . . drilling (feed for cutting)

N0411 G00 Z300.;

N0412 X210. Y480. M5; . . . stop of main spindle

N0413 G00 X210.;

N0414 G00 Z300.;

However, in the case where a machining program for opening a plurality of holes positioned at predetermined intervals as described above is supplied, when a main spindle revolution instruction (M3) is given, the conventional numerically controlled apparatus performs a numerical control for immediately revolving the main spindle at the instructed speed (S1500) and keeping the state where the main spindle revolves also at the time of shift for positioning between cutting operations.

It is therefore necessary to preliminarily revolve the main spindle before the cutting operation. However, there is a case such that even the main spindle revolution instruction (M3) is included in the machining program, the main spindle does not have to be revolved immediately. In this case, the power is consumed unnecessarily.

The revolution of the main spindle at the time of shift for positioning between the cutting operations does not contribute to the machining, so that the power is consumed unnecessarily.

### DISCLOSURE OF THE INVENTION

The present invention has been achieved to solve the problems and its object is to provide a numerical control method and a numerically controlled apparatus capable of reducing unnecessary power consumption in a case where a peripheral speed uniforming instruction is given during a machining program.

Another object of the invention is to provide a numerical control method and a numerically controlled apparatus capable of reducing unnecessary power consumption when a main spindle revolution instruction is given during a machining program.

The other objects of the invention will become apparent from the description of “BEST MODE FOR CARRYING OUT THE INVENTION”.

According to the invention, there is provided a numerical control method of controlling a numerically controlled apparatus having a peripheral speed uniforming control function for controlling speed of a main spindle so that a peripheral speed becomes constant in accordance with a change in position of a reference axis during feed for cutting, comprising the steps of, preliminarily reading and analyzing a block preceding a present block by one or more blocks, and, on the basis of a result of the pre-reading and analysis, controlling a timing of starting the peripheral speed uniforming control function.

According to the invention, there is provided a numerical control method of controlling a numerically controlled apparatus having a peripheral speed uniforming control function for controlling speed of a main spindle so that a peripheral speed becomes constant in accordance with a change in position of a reference axis during feed for cutting, comprising the steps of, preliminarily reading and analyzing a block preceding a present block by one or more blocks, on the basis of a result of the pre-reading and analysis, obtaining execution time since a peripheral speed uniforming instruction is given until feed for cutting is started and main spindle reach time required to make the speed of the main spindle before the peripheral speed uniforming instruction reach the speed of the main spindle according to the peripheral speed uniforming instruction, and controlling a timing of starting the peripheral speed uniforming control function on the basis of the execution time and the main spindle reach time obtained.

According to the invention, there is provided a numerically controlled apparatus having a peripheral speed uniforming control function for controlling speed of a main spindle so that a peripheral speed becomes constant in accordance with a change in position of a reference axis during feed for cutting, including, a program pre-reading and analyzing unit which preliminarily reads and analyzes a block preceding a present block by one or more blocks, and a peripheral speed uniforming control function start timing calculating unit which controls a timing of starting the peripherals peed uniforming control function on the basis of a result of the pre-reading and analysis of the program pre-reading and analyzing unit.

According to the invention, there is provided a numerically controlled apparatus having a peripheral speed uniforming control function for controlling speed of a main spindle so that a peripheral speed becomes constant in accordance with a change in position of a reference axis during feed for cutting, including, a program pre-reading and analyzing unit which pre-reads and analyzes a block preceding a present block by one or more blocks, a unit which obtains execution time since a peripheral speed uniforming instruction is given until feed for cutting is started and main spindle reach time required to make the speed of the main spindle before the peripheral speed uniforming instruction reach the speed of the main spindle according to the peripheral speed uniforming instruction on the basis of a result of the pre-reading and analysis of the program pre-reading and analyzing unit, and a peripheral speed uniforming control function start timing calculating unit which controls a timing of starting the peripheral speed uniforming control function on the basis of the execution time and the main spindle reach time obtained by the unit.

In the numerically controlled apparatus according to the invention, the peripheral speed uniforming control function start timing calculating unit starts the peripheral speed uniforming control function after time obtained by subtracting the main spindle reach time required to make the speed of the main spindle before the peripheral speed uniforming instruction reach the speed of the main spindle at the start of cutting operation according to the peripheral speed uniforming instruction from the execution time elapses since the peripheral speed uniforming instruction.

In the numerically controlled apparatus according to the invention, each of the execution time and main spindle reach time is converted to the number of sampling times of software and the obtained number of sampling times is used.

In the numerically controlled apparatus according to the invention, an acceleration curve or a deceleration curve of the main spindle is approximated by a plurality of straight lines, and the main spindle reach time is estimated on the basis of an equation of the straight line.

According to the invention, there is provided a numerical control method of controlling a numerically controlled apparatus having a function of controlling the speed of a main spindle, comprising the steps of, preliminarily reading and analyzing a block preceding a present block by one or more blocks, and controlling a timing of starting the main spindle on the basis of a result of the pre-reading and analysis.

According to the invention, there is provided a numerical control method of controlling a numerically controlled apparatus having a function of controlling the speed of a main spindle, comprising the steps of, preliminarily reading and analyzing a block preceding a present block by one or more blocks, on the basis of a result of the pre-reading and analysis, obtaining execution time since a peripheral speed uniforming instruction is given until feed for cutting is started and main spindle reach time required to reach the speed of the main spindle according to the peripheral speed uniforming instruction from start of the main spindle, and controlling a timing of starting the main spindle on the basis of the execution time and the main spindle reach time obtained.

According to the invention, there is provided a numerically controlled apparatus having a function of controlling speed of a main spindle, including, a program pre-reading and analyzing unit which preliminarily reads and analyzes a block preceding a present block by one or more blocks, and a main spindle start timing calculating unit which controls a timing of starting the main spindle on the basis of a result of the pre-reading and analysis of the program pre-reading and analyzing unit.

According to the invention, there is provided a numerically controlled apparatus having a function of controlling speed of a main spindle, including, a program pre-reading and analyzing unit which pre-reads and analyzes a block preceding a present block by one or more blocks, a unit which obtains execution time since a main spindle revolution instruction is given until feed for cutting is started and main spindle acceleration time required to reach the speed of the main spindle according to the main spindle revolution instruction from start of the main spindle on the basis of a result of the pre-reading and analysis of the program pre-reading and analyzing unit, and a main spindle start timing calculating unit which controls a timing of starting the main spindle on the basis of the execution time and the main spindle acceleration time obtained by the unit.

In the numerically controlled apparatus according to the invention, the main spindle start timing calculating unit starts the main spindle after time obtained by subtracting the main spindle acceleration time from the execution time elapses since the main spindle revolution instruction.

In the numerically controlled apparatus according to the invention, each of the execution time and main spindle acceleration time is converted to the number of sampling times of software and the obtained number of sampling times is used.

In the numerically controlled apparatus according to the invention, an acceleration curve or a deceleration curve of the main spindle is approximated by a plurality of straight lines, and the main spindle acceleration time is estimated on the basis of an equation of the straight line.

According to the invention, there is provided a numerical control method of controlling a numerically controlled apparatus having a function of controlling speed of a main spindle, comprising the steps of, preliminarily reading and analyzing a block preceding a present block by one or more blocks, and when a result of the pre-reading and analysis satisfies a predetermined condition, stopping the main spindle even during a main spindle revolution instruction.

According to the invention, there is provided a numerical control method of controlling a numerically controlled apparatus having a function of controlling speed of a main spindle, comprising the steps of, preliminarily reading and analyzing a block preceding a present block by one or more blocks, when a result of the pre-reading and analysis shows that it is during a main spindle revolution instruction and a non-cutting block exists, obtaining main spindle stop time between the non-cutting block and start of feed for cutting and acceleration/deceleration time of the main spindle on the basis of the result of the pre-reading and analysis, comparing the main spindle stop time obtained with the acceleration/deceleration time of the main spindle, and stopping the main spindle even during the main spindle revolution instruction when the main spindle stop time is longer than the acceleration/deceleration time of the main spindle.

According to the invention, there is provided a numerically controlled apparatus having a function of controlling speed of a main spindle, including, a program pre-reading and analyzing unit which pre-reads and analyzes a block preceding a present block by one or more blocks, and a main spindle stop timing calculating unit which stops the main spindle even during a main spindle revolution instruction when a result of the pre-reading and analysis performed by the program pre-reading and analyzing unit satisfies a predetermined condition.

According to the invention, there is provided a numerically controlled apparatus having a function of controlling speed of a main spindle, including, a program pre-reading and analyzing unit which preliminarily reads and analyzes a block preceding a present block by one or more blocks, a unit which obtains main spindle stop time between a non-cutting block and start of feed for cutting and acceleration/deceleration time of the main spindle on the basis of the result of the pre-reading and analysis when a result of the pre-reading and analysis shows that it is during the main spindle revolution instruction and a non-cutting block exists, and a main spindle stop timing calculating unit which compares the main spindle stop time with the acceleration/deceleration time of the main spindle obtained by the unit and, when the former is longer the latter, stops the main spindle even during the main spindle revolution instruction.

In the numerically controlled apparatus according to the invention, an acceleration curve or a deceleration curve of the main spindle is approximated by a plurality of straight lines, and the acceleration/deceleration time of the main spindle is estimated on the basis of an equation of the straight line.

According to the invention, there is provided a numerical control method comprising the steps of preliminarily reading and analyzing a block preceding a present block by one or more blocks and controlling a timing of starting a peripheral speed uniforming control function and a timing of starting a main spindle on the basis of a result of the pre-reading and analysis.

According to the invention, there is provided a numerical control method comprising the steps of, preliminarily reading and analyzing a block preceding a present block by one or more blocks, on the basis of a result of the pre-reading and analysis, obtaining first execution time since a peripheral speed uniforming instruction is given until feed for cutting is started, main spindle reach time required to make speed of a main spindle before the peripheral speed uniforming instruction reach the speed of the main spindle at the start of cutting according to the peripheral speed uniforming instruction, second execution time since a main spindle revolution instruction is given until feed for cutting is started, and main spindle acceleration time since the main spindle is started until the speed of the main spindle at the start of cutting according to the main spindle revolution instruction is reached, and starting the peripheral speed uniforming control function after elapse of time obtained by subtracting the main spindle reach time from the first execution time since the peripheral speed uniforming instruction, and starting the main spindle after time obtained by subtracting the main spindle acceleration time from the second execution time elapses since the main spindle revolution instruction.

According to the invention, there is also provided a numerically controlled apparatus including, a program pre-reading and analyzing unit which preliminarily reads and analyzes a block preceding a present block by one or more blocks, a peripheral speed uniforming control function start timing calculating unit which controls a timing of starting a peripheral speed uniforming control function on the basis of a result of the pre-reading and analysis of the program pre-reading and analyzing unit, and a main spindle start timing calculating unit which controls a timing of starting the main spindle on the basis of a result of pre-reading and analysis of the program pre-reading and analyzing unit.

According to the invention, there is also provided a numerically controlled apparatus including, a program pre-reading and analyzing unit which preliminarily reads and analyzes a block preceding a present block by one or more blocks, a unit which obtains, on the basis of a result of pre-reading and analysis of the program pre-reading and analyzing unit, first execution time since a peripheral speed uniforming instruction is given until feed for cutting is started, main spindle reach time required to make speed of a main spindle before the peripheral speed uniforming instruction reach the speed of the main spindle at the start of cutting according to the peripheral speed uniforming instruction, second execution time since a main spindle revolution instruction is given until feed for cutting is started, and main spindle acceleration time required to reach the speed of the main spindle according to the main spindle revolution instruction from start of the main spindle, a peripheral speed uniforming control function start timing calculating unit which starts the peripheral speed uniforming control function after elapse of time obtained by subtracting the main spindle reach time from the first execution time since the peripheral speed uniforming instruction, and a main spindle start timing calculating unit which starts the main spindle after time obtained by subtracting the main spindle acceleration time from the second execution time elapses since the main spindle revolution instruction.

According to the invention, there is also provided a numerical control method comprising the steps of, preliminarily reading and analyzing a block preceding a present block by one or more blocks, controlling a timing of starting a peripheral speed uniforming control function on the basis of a result of the pre-reading and analysis, and stopping a main spindle even during a main spindle revolution instruction when the result of pre-reading and analysis satisfies a predetermined condition.

According to the invention, there is also provided a numerical control method comprising the steps of, preliminarily reading a block preceding a present block by one or more blocks, on the basis of a result of the pre-reading and analysis, obtaining first execution time since a peripheral speed uniforming instruction is given until feed for cutting is started and main spindle reach time required to make speed of a main spindle before the peripheral speed uniforming instruction reach the speed of the main spindle at the start of cutting operation according to the peripheral speed uniforming instruction, when a result of the pre-reading and analysis shows that it is during the main spindle revolution instruction and a non-cutting block exists, on the basis of a result of the pre-reading and analysis, obtaining main spindle stop time between the non-cutting block and start of feed for cutting and acceleration/deceleration time of the main spindle, starting the peripheral speed uniforming control function after time obtained by subtracting the main spindle reach time from the first execution time elapses since the peripheral speed uniforming instruction, comparing the main spindle stop time with the acceleration/deceleration time of the main spindle, and when the main spindle stop time is longer than the acceleration/deceleration time of the main spindle, stopping the main spindle even during the main spindle revolution instruction.

According to the invention, there is also provided a numerically controlled apparatus including, a program pre-reading and analyzing unit which preliminarily reads and analyzes a block preceding a present block by one or more blocks, a peripheral speed uniforming control function start timing calculating unit which controls a timing of starting a peripheral speed uniforming control function on the basis of a result pre-reading and analysis of the program pre-reading and analyzing unit, and a main spindle stop timing calculating unit which stops a main spindle even during a main spindle resolution instruction when the result of pre-reading and analysis of the program pre-reading and analysis unit satisfies a predetermined condition.

According to the invention, there is also provided a numerically controlled apparatus including, a program pre-reading and analyzing unit which preliminarily reads and analyzes a block preceding a present block by one or more blocks, a unit which obtains, on the basis of a result of pre-reading and analysis of the program pre-reading and analyzing unit, first execution time since a peripheral speed uniforming instruction is given until feed for cutting is started and main spindle reach time required to make speed of a main spindle before the peripheral speed uniforming instruction reach the speed of the main spindle at the start of cutting according to the peripheral speed uniforming instruction, a unit which obtains main spindle stop time between a non-cutting block and start of feed for cutting and acceleration/deceleration time of the main spindle on the basis of a result of the pre-reading and analysis of the program pre-reading and analyzing unit when the result of the pre-reading and analysis shows that it is during a main spindle revolution instruction and the non-cutting block exists, a peripheral speed uniforming control function start timing calculating unit which starts the peripheral speed uniforming control function after elapse of time obtained by subtracting the main spindle reach time from the first execution time since the peripheral speed uniforming instruction, and a main spindle stop timing calculating unit which compares the main spindle stop time and the acceleration/deceleration time of the main spindle obtained by the unit with each other and, when the former is longer than the latter, stops the main spindle even in the main spindle revolution instruction.

According to the invention, there is also provided a numerical control method comprising the steps of, preliminarily reading and analyzing a block preceding a present block by one or more blocks, controlling a timing of starting a main spindle on the basis of a result of the pre-reading and analysis, and stopping the main spindle even during a main spindle revolution instruction when the result of pre-reading and analysis satisfies a predetermined condition.

According to the invention, there is also provided a numerical control method comprising the steps of, preliminarily reading a block preceding a present block by one ormore blocks, on the basis of a result of the pre-reading and analysis, obtaining second execution time since a main spindle instruction is given until feed for cutting is started and main spindle acceleration time since start of the main spindle until speed of the main spindle according to the main spindle revolution instruction is reached, when the result of the pre-reading and analysis shows that it is during the main spindle revolution instruction and a non-cutting block exists, on the basis of the result of the pre-reading and analysis, obtaining main spindle stop time between the non-cutting block and start of feed for cutting and acceleration/deceleration time of the main spindle, starting the main spindle after time obtained by subtracting the acceleration time of the main spindle from the second execution time elapses since the main spindle revolution instruction, comparing the main spindle stop time with the acceleration/deceleration time of the main spindle, and when the main spindle stop time is longer than the acceleration/deceleration time of the main spindle, stopping the main spindle even during the main spindle revolution instruction.

According to the invention, there is also provided a numerically controlled apparatus including, a program pre-reading and analyzing unit which preliminarily reads and analyzes a block preceding a present block by one or more blocks, a main spindle start timing calculating unit which controls a timing of starting a main spindle on the basis of a result of pre-reading and analysis of the program pre-reading and analyzing unit, and a main spindle stop timing calculating unit which stops a main spindle even during a main spindle resolution instruction when the result of pre-reading and analysis of the program pre-reading and analysis unit satisfies a predetermined condition.

According to the invention, there is also provided a numerically controlled apparatus including, a program pre-reading and analyzing unit which preliminarily reads and analyzes a block preceding a present block by one or more block, a unit which obtains, on the basis of a result of pre-reading and analysis of the program pre-reading and analyzing unit, second execution time since a peripheral speed uniforming instruction is given until feed for cutting is started and main spindle acceleration time since the main spindle is started until speed of the main spindle according to the main spindle revolution instruction is reached, a unit, when a result of the pre-reading and analysis shows that it is during the main spindle revolution instruction and a non-cutting block exists, for obtaining main spindle stop time between the non-cutting block and start of feed for cutting and acceleration/deceleration time of the main spindle on the basis of the result of the pre-reading and analysis, a main spindle start timing calculating unit which starts the main spindle after elapse of time obtained by subtracting the main spindle acceleration time from the second execution time since the main spindle resolution instruction, and a main spindle stop timing calculating unit which compares the main spindle stop time and the acceleration/deceleration time of the main spindle obtained by the unit and, when the former is longer than the latter, stops the main spindle even during the main spindle revolution instruction.

### BRIEF DESCRIPTION OF THE DRAWINGS

FIG. 1 is a block diagram showing the configuration of a numerically controlled apparatus according to a first embodiment of the invention.

FIG. 2 is a diagram showing an example of the configuration of a prefetch buffer according to the first embodiment of the invention.

FIG. 3 is a flowchart showing a procedure of a program pre-reading and analyzing unit according to the first embodiment of the invention.

FIG. 4 is a flowchart showing the procedure of a peripheral speed uniforming control function start timing calculating unit according to the first embodiment of the invention.

FIG. 5 is an explanatory diagram regarding main spindle acceleration time estimating unit according to the first embodiment of the invention.

FIG. 6 is an explanatory diagram showing movement of a reference axis and movement of the speed of a main spindle at the time of peripheral speed uniforming control according to the first embodiment of the invention.

FIG. 7 is a block diagram showing the configuration of a numerically controlled apparatus according to a second embodiment of the invention.

FIG. 8 is a flowchart showing the procedure of a program pre-reading and analyzing unit according to the second embodiment of the invention.

FIG. 9 is a flowchart showing the procedure of a main spindle start timing calculating unit according to the second embodiment of the invention.

FIG. 10 is a flowchart showing the procedure of a main spindle stop timing calculating unit according to the second embodiment of the invention.

FIG. 11 is an explanatory diagram showing a change in the speed of the main spindle according to the second embodiment of the invention.

FIG. 12 is a block diagram showing the configuration of the numerically controlled apparatus having a conventional peripheral speed uniforming control function.

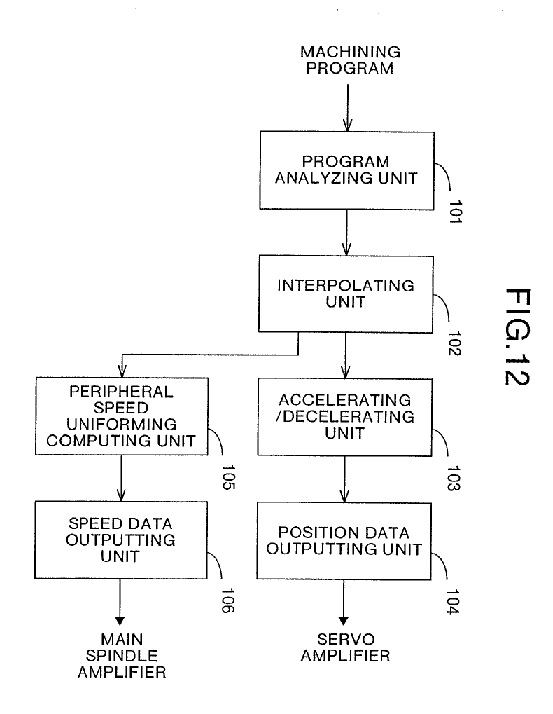

FIG. 13 is an explanatory diagram showing the operation at the time of conventional peripheral speed uniforming control.

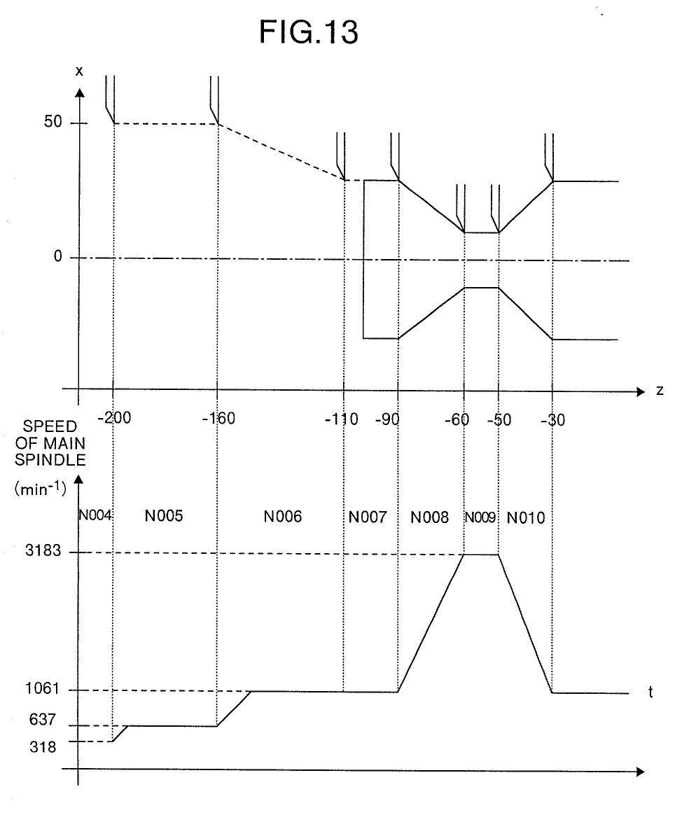

### BEST MODE FOR CARRYING OUT THE INVENTION

First Embodiment

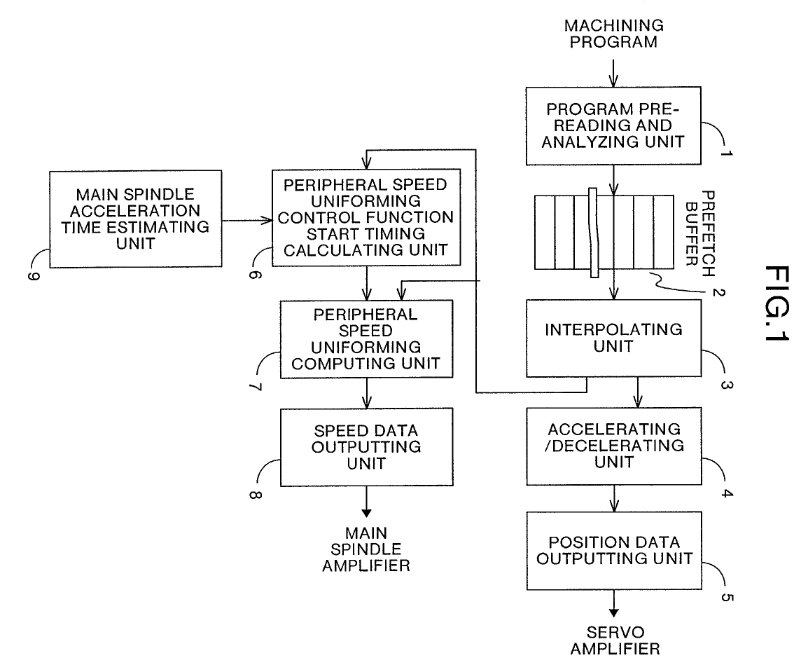

A first embodiment of the invention will be described with reference to FIGS. 1 to 6.

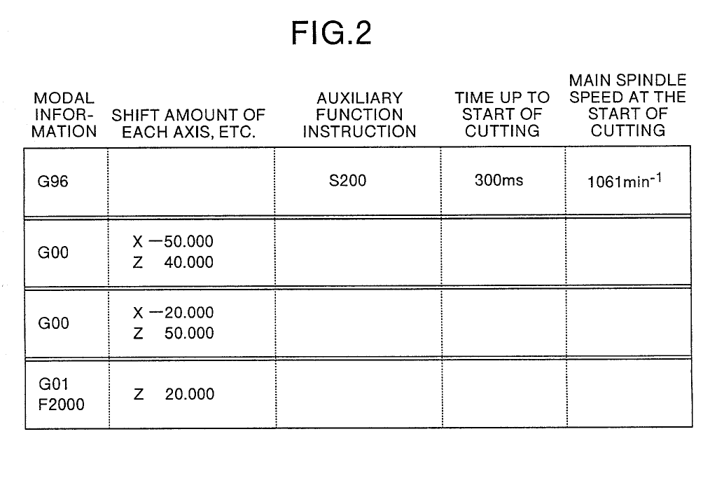

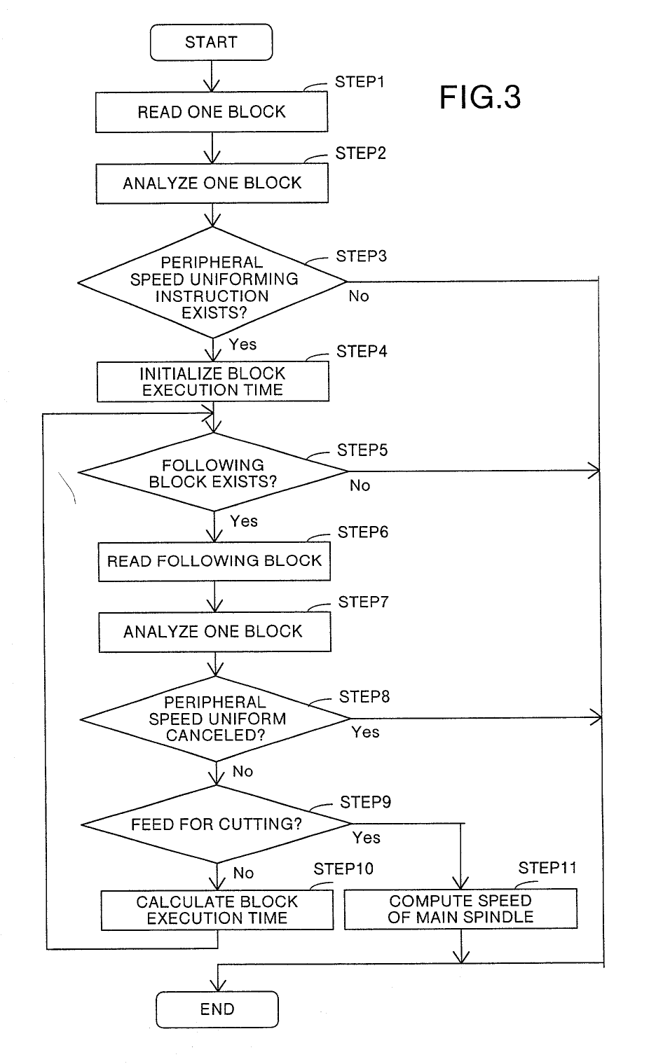

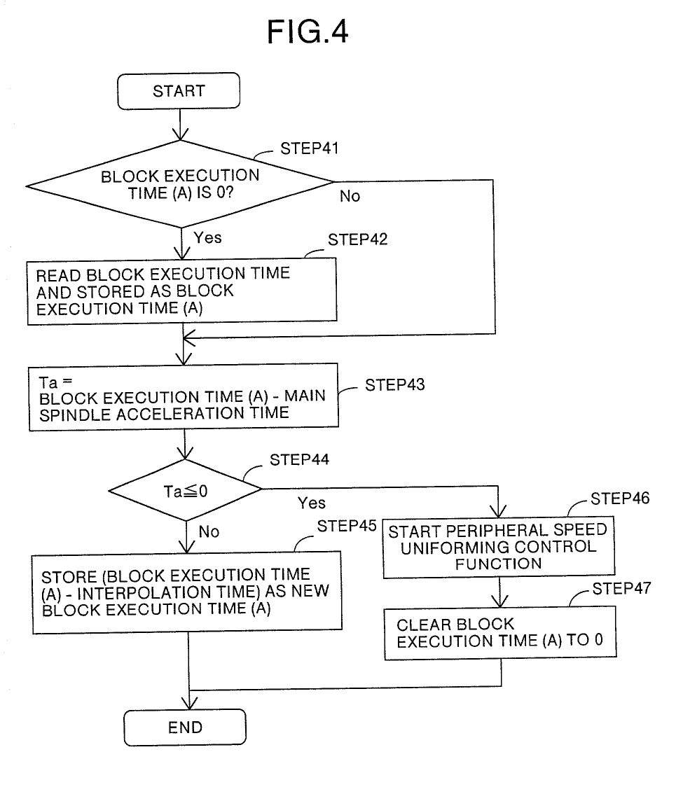

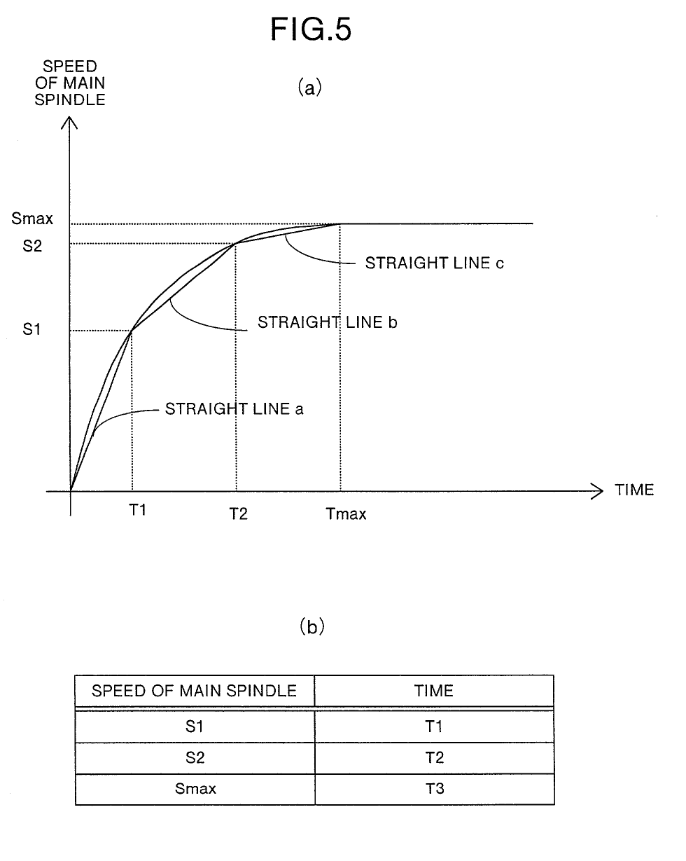

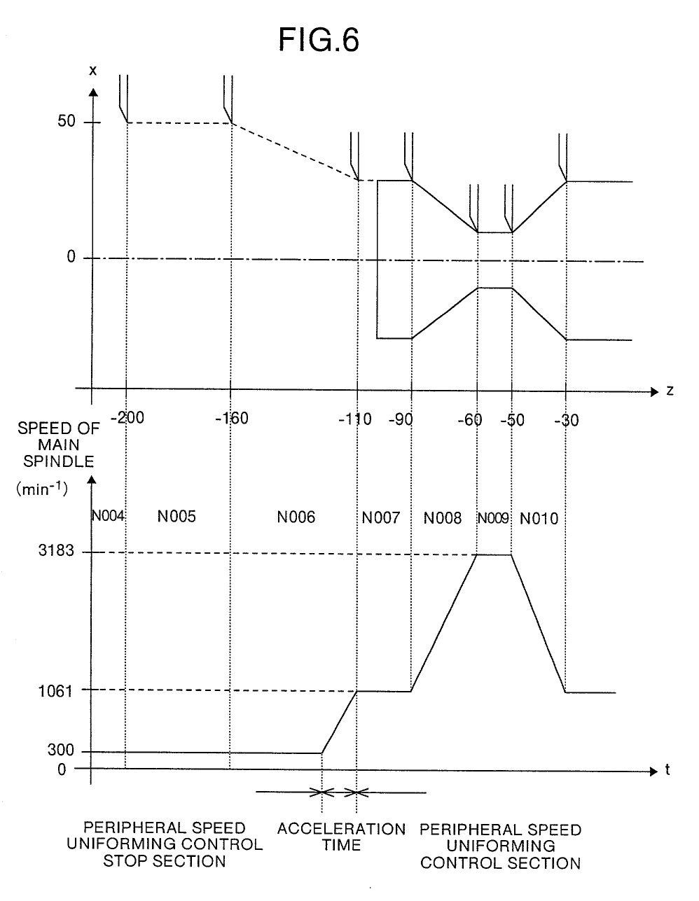

The first embodiment is directed to suppress power consumed unnecessarily in the case where a peripheral speed uniforming control instruction is given like in the machining program A. FIG. 1 is a block diagram showing the configuration of a numerically controlled apparatus according to the first embodiment of the invention. FIG. 2 is a diagram showing an example of the configuration of a prefetch buffer according to the first embodiment of the invention. FIG. 3 is a flowchart showing a procedure of a program pre-reading and analyzing unit according to the first embodiment of the invention. FIG. 4 is a flowchart showing the procedure of a peripheral speed uniforming control function start timing calculating unit according to the first embodiment of the invention. FIG. 5 is an explanatory diagram regarding main spindle acceleration time estimating unit according to the first embodiment of the invention. FIG. 6 is an explanatory diagram showing movement of a reference axis and movement of the speed of a main spindle according to the first embodiment of the invention.

In FIG. 1, 1 denotes a program pre-reading and analyzing unit which reads a block preceding a block being presently processed by one or more blocks from a machining program, analyzes the read block, and stores a result of analysis into a prefetch buffer 2. In the prefetch buffer 2, information such as modal information of each block, shift amount of each axis, instructed speed of the main spindle, feed speed, and peripheral speed uniforming control function start timing information is stored. 3 denotes an interpolating unit activated every predetermined sampling cycle (for example, 10 ms), which reads block information to be processed from the prefetch buffer 2 and executes an interpolating process. The result of interpolation is accelerated or decelerated by an accelerating/decelerating unit 4, and the resultant is output via a position data outputting unit 5 to a servo amplifier. The interpolating unit 3, an accelerating/decelerating unit 4, and a position data outputting unit 5 are units conventionally used.

6 indicates a peripheral speed uniforming control function start timing calculating unit which determines a timing of starting a peripheral speed uniforming computing unit 7 from execution time since the peripheral speed uniforming instruction stored in the prefetch buffer 2 and read by the interpolating unit 3 is given up to start of cutting operation, the speed of the main spindle at the start of cutting, main spindle acceleration time, and the like. When the peripheral speed uniforming computing unit 7 is started, the peripheral speed constant control function timing calculating unit 6 outputs a start signal. 7 denotes the peripheral speed uniforming computing unit which computes the speed of the main spindle according to the coordinate value of the reference axis during feed for cutting and maintains the peripheral speed constant. 8 indicates a speed data outputting unit which supplies an instruction of the speed of the main spindle to a main spindle amplifier. 9 denotes a main spindle acceleration time estimating unit which estimates time required to accelerate the main spindle to the instructed speed.

FIG. 2 shows an example of the configuration of the prefetch buffer 2 in FIG. 1. In the prefetch buffer 2, information is generated on the block unit basis. The prefetch buffer 2 includes an area storing modal information of a G code and the like, an area storing an axis shift instruction, an area storing a code of an auxiliary/main spindle function instruction such as M instruction or S instruction, an area storing execution time since the peripheral speed uniforming instruction is given until the cutting operation is started, and an area storing the speed of the main spindle at the start of cutting operation.

In FIG. 2, analysis from N004 G96 S200 to N007 G01 Z-90. F2000 has been finished, and a block being processed is the head of the prefetch buffer, that is, N004 G96 S200.

The program pre-reading and analyzing unit 1 shown in FIG. 1 reads and analyzes data on the block unit basis from the machining program. When the peripheral speed uniforming start instruction G96 is read, the program pre-reading and analyzing unit 1 pre-reads the machining program and analyzes blocks until a cutting block such as G01 appears. On completion of the pre-reading and analysis to the cutting block, execution time between the present block (block of the peripheral speed uniforming start instruction G96) to the start of the cutting block and the speed of the main spindle in cutting start position are calculated. The time and speed are stored in the main spindle control information storing areas of the block area of G96in the prefetch buffer 2 (area storing the time up to the start of cutting and the area storing the spindle speed at the start of cutting).

The detailed operations of the program pre-reading and analyzing unit 1 will now be described with reference to FIG. 3.

First, one block is read from the machining program at step 1 and analyzed at step 2. At step 3, whether the peripheral speed uniforming instruction G code “G96” is included in the analyzed block or not is determined. If No, the analysis is finished. If “G96” is included, the routine advances to step 4 where time data up to start of cutting which will be calculated later is initialized.

At step 5, whether there is the following block in the machining program or not is determined. When there is the following block, the routine advances to step 6 where the following block is read. At step 7, the read block is analyzed. If the block analyzed at step 7 includes a peripheral speed uniforming instruction cancel G code “G97”, the analysis is finished. When “G97” is not included, whether the process is feed for cutting or not is determined at step 9. If Yes, the routine advances to step 11 where the speed of the main spindle as the peripheral speed instructed is computed from the reference axis coordinates at the cutting start point on the basis of equation 1 and stored into the area storing the speed of the main spindle at the cutting start point in the prefetch buffer 2. When feed for cutting is not determined at step 9, the execution time on the block is calculated at step 10 and stored in the area storing the time up to the start of cutting in the prefetch buffer 2.

The execution time of a block is calculated by the following procedure.

(1) In the case of only a fast feed instruction block,

shift time of the axis having the longest shift distance in the block is calculated and acceleration/deceleration time is added.

For example, the execution time in the case where fast feed speed is 60 m/min, acceleration/deceleration time constant is 200 ms, and shift distance is 500 mm is calculated as follows.

500[mm]/((60×1000)/(60×1000) [mm/msec]+200[msec]=700[msec]

(2) In the case of only an auxiliary function,

auxiliary function execution time is preset as a parameter and is used as the execution time of the block. Specifically, the execution time is prestored in a predetermined position in a parameter memory like “M03:Tm1 (execution time), M04:Tm2 . . . ”. For example, when M03 is analyzed, Tm1 is read and Tm1 is used as execution time.

(3) In the case where a block includes both the fast feed instruction and the auxiliary function instruction,

the fast feed execution time and the auxiliary function execution time are compared with each other and the longer one is used as the execution of the block.

(4) In the case of a dwell instruction (G04),

dwell time is used as the execution time of the block.

(5) In the case where a block do not include both the fast feed instruction and auxiliary function instruction,

for example, this is the case of only modal setting of the G code. The process period of the peripheral speed uniforming control function start timing calculating unit 6, for example, 10 msec is used as the execution time of the block.

After calculating the block execution time in such a manner, the operations are repeatedly executed from step 5 and the execution time of blocks are added up until the cutting feed instruction appears.

That is, the accumulated time of the block execution time is equal to the time since the G96 is instructed until the cutting is actually started. The block execution time and the speed of the main spindle are stored into the area storing time up to the start of cutting and the area storing the speed of the main spindle at the start of cutting in the G96 block in the prefetch buffer 2.

The detailed operation of the peripheral speed uniforming control function start timing calculating unit 6 will now be described with reference to FIG. 4.

By the time the process is started for the first time, block execution time (A) shown in FIG. 4 is initialized (cleared to 0) and stored in a memory (not shown) in the numerically controlled apparatus according to the invention.

First, at step 41, whether the process is the first one or not is determined. In this case, when the block execution time (A) is “0”, the process is determined as the first process. When the block execution time (A) is not “0”, the process is determined as a second process or any of the subsequent processes.

When the process is the first process, at step 42, the block execution time stored in the block information being processed at present in the prefetch buffer 2 is read and stored as the block execution time (A).

The block execution time indicates 300 ms which is time up to the start of cutting operation shown in FIG. 2.

At step 43, Ta (=block execution time (A)—main spindle acceleration time (main spindle reach time which is required to make the speed of the main spindle before the peripheral speed uniforming instruction reach the speed of the main spindle necessary at the start of the cutting block) is obtained. A method of estimating acceleration time of the main spindle will be described hereinlater.

At step 44, whether Ta is equal to or smaller than 0 is determined. If No, at step 45, interpolation time is subtracted from the block execution time (A) and the resultant is stored as new block execution time (A) into the memory and the process is finished. In the second and subsequent times, since the data of the block execution time (A) stored at step 45 is already stored in the memory and the block execution time (A) is not “0”, the process is determined as the second or later process at step 41. On the basis of this data, step 43 and subsequent steps are executed.

When Ta is 0 or smaller at step 44, at step 46, the peripheral speed uniforming computing unit 7 for changing the instructed speed of the main spindle so that the peripheral speed becomes constant in accordance with the coordinate value of the cutting feed block is started. Since the main spindle reaches the instructed speed with certain acceleration time, it reaches the instructed speed of the main spindle at the start of the cutting feed block.

Finally, at step 47, the block execution time (A) is cleared to “0”, thereby finishing the process.

The peripheral speed uniforming control function start timing calculating unit 6 is periodically processed in predetermined sampling cycles and the above processes are repeated.

In the first embodiment, the block execution time (for example, 300 ms in the case of FIG. 2) by the program pre-reading and analyzing unit 1. In place of the execution time, a value obtained by dividing the execution time by the sampling cycle of the peripheral speed uniforming control function start timing calculating unit 6, that is, the number of sampling times of the peripheral speed uniforming control function start timing calculating unit 6 may be used. For example, when it is assumed that the sampling cycle of the peripheral speed uniforming control function start timing calculating unit 6 is 10 ms, the number of sampling times becomes (300/10=) 30 times. Further, each of all the data indicative of time such as the main spindle acceleration time, block execution time (A), and interpolation time is converted to the number of sampling times of the peripheral speed uniforming control function start timing calculating unit 6 and replaced with the data in FIG. 4, for example, “subtraction of the interpolation time” at step 45 becomes subtraction of only “1” since the interpolation time is 10 ms, and all of the calculations after the conversion of the number of sampling times become only a subtracting process using integers and no fractions. Therefore, the process becomes simpler and is dealt more easily in a software process.

Although a fraction may occur at the time of the conversion of the number of sampling times, in this case, a process of rounding up or off the fraction to an integer is performed.

The main spindle acceleration time estimating unit 9 will now be described by referring to FIG. 5.

It is assumed that the maximum speed of the main spindle is Smax and it takes time of only Tmax to accelerate the main spindle to Smax. When the instructed speed of the main spindle is lower than Smax, generally, the instructed speed is reached while drawing an acceleration curve close to an acceleration curve to Smax. Since the acceleration curve at the time of performing acceleration to Smax is preliminarily known, acceleration time to reach an instructed arbitrary speed can be estimated. However, when the acceleration curve is expressed by a mathematical equation, it becomes complicated and difficult to actually obtain acceleration time which is required to reach an arbitrary speed. Consequently, by approximating the acceleration curve by one or more straight lines, acceleration time is obtained.

First, an acceleration waveform up to the maximum speed of the main spindle is measured. Although any measuring unit may be used, for example, a velocity waveform is recorded on a recording sheet by using a synchroscope or the like.

Subsequently, a straight light is drawn along the acceleration curve on the recording sheet while an error becomes a proper value.

FIG. 5(a) shows an example of approximating the acceleration curve to Smax by three straight lines a, b, and c. Each of the straight lines is obtained by connecting two points on the acceleration curve to Smax while an error is within a proper permissible range. In the case of further reducing an approximation error, it is sufficient to use the larger number of points on the curve.

In this example, acceleration time from the instructed speed 0 to the speed S1 of the main spindle is T1, acceleration time from 0 to the speed S2 of the main spindle is T2, and acceleration time from 0 to the speed Smax of the main spindle is Tmax.

The speed of the main spindle and acceleration times obtained as above are set in a memory of the numerically controlled apparatus as shown in FIG. 5(b). The data is stored in a nonvolatile RAM (not shown) in the numerically controlled apparatus.

Next, the equation of the straight line of each section is obtained and acceleration time according to the instructed speed is calculated as follows.

The acceleration time when 0<instructed speed≦S1 is obtained by

acceleration time T=(T1/S1)×instructed speed.

The acceleration time when S1<instructed speed≦S2 is obtained by

acceleration time T=(S2×T1−S₁×T230 (T2−T1)×instructed speed)/(S2−S1).

The acceleration time when S2<instructed speed≦Smax is obtained by acceleration time T=(Smax×T2−S2×Tmax+(Tmax−T2)×instructed speed)/(Smax−S2).

Therefore, first, the section to which the instructed speed of the main spindle belongs is determined and, next, calculation is executed by substituting the instructed speed into the corresponding equation, thereby enabling the acceleration time according to the speed of the main spindle to be easily calculated.

Although the acceleration time of the acceleration curve of the main spindle is used to calculate the main spindle acceleration time (main spindle reach time required to make the speed of the main spindle before the peripheral speed uniforming instruction reach the speed of the main spindle according to the peripheral speed uniforming instruction), alternately, deceleration time of a deceleration curve may be used.

FIG. 6 is an explanatory diagram showing movement of the reference axis and that of the speed of the main spindle at the time of the peripheral speed uniforming control in the first embodiment. Conventionally, the speed of the main spindle is controlled so that the peripheral speed becomes constant also on the block of fast feed as an approaching operation up to the cutting point. In contrast, in the first embodiment, the speed of the main spindle can be controlled without waste so as to reach the instructed speed as necessary. Thus, since the main spindle acceleration/deceleration control is not performed in blocks of positioning and the like which do not contribute to machining, the power is not consumed uselessly.

In the first embodiment, the case of executing the calculation of execution time since the peripheral speed uniforming instruction is given until the feed for cutting is started by the program pre-reading and analyzing unit 1 has been described. Also by executing the calculation by means other than the program pre-reading and analyzing unit 1, the initial object can be achieved.

In order to simplify the calculation of the main spindle reach time required to make the speed of the main spindle before the peripheral speed uniforming instruction reach the speed of the main spindle according to the peripheral speed uniforming instruction, the acceleration curve of the main spindle is approximated by a plurality of straight lines and the main spindle reach time is obtained on the basis of the equation of the straight line. Alternately, by approximating a deceleration curve by a plurality of straight lines and obtaining the main spindle reach time on the basis of an equation of the straight light, the initial object can be also achieved.

In the first embodiment, in order to maximally reduce the power consumed by the peripheral speed uniforming control, after elapse of time obtained by subtracting the main spindle reach time required to make the speed of the main spindle before the peripheral speed uniforming instruction reach the speed of the main spindle at the start of cutting operation according to the peripheral speed uniforming instruction from the execution time since the peripheral speed uniforming instruction is given up to the start of feed for cutting operation since the peripheral speed uniforming instruction is given, the peripheral speed uniforming control function is started, that is, the peripheral speed uniforming control function is started in some midpoint of the block N006. Also by starting the peripheral speed uniforming control function in a block (block N005) which is preceding from the start point of cutting operation by two blocks, the initial object can be achieved.

Second Embodiment

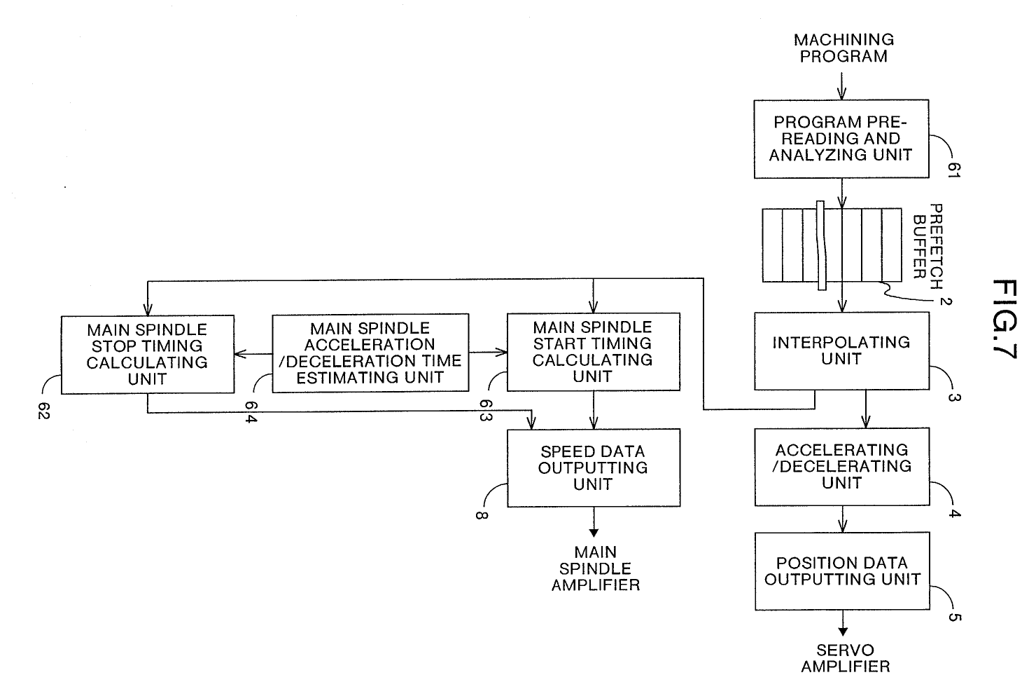

A second embodiment of the invention will now be described with reference to FIGS. 7 to 11.

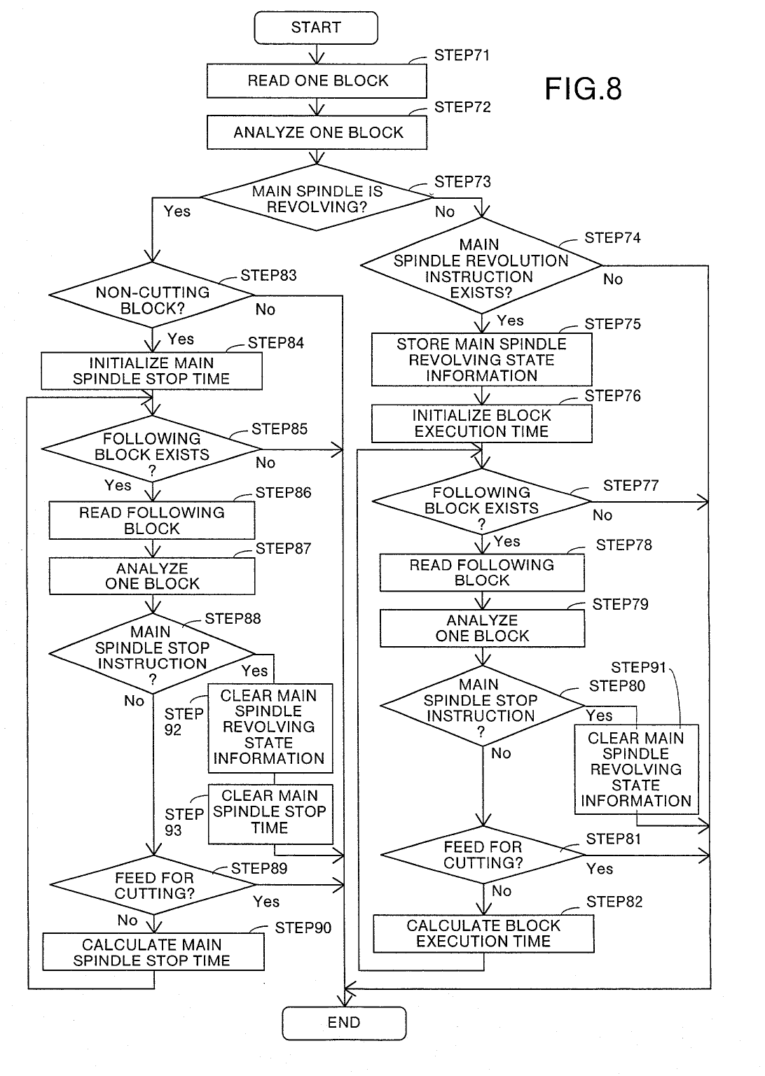

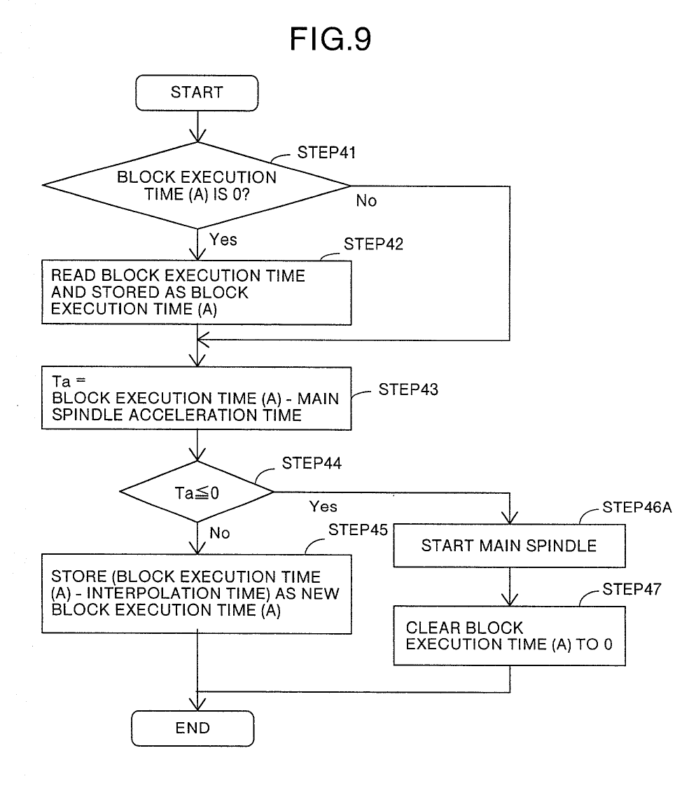

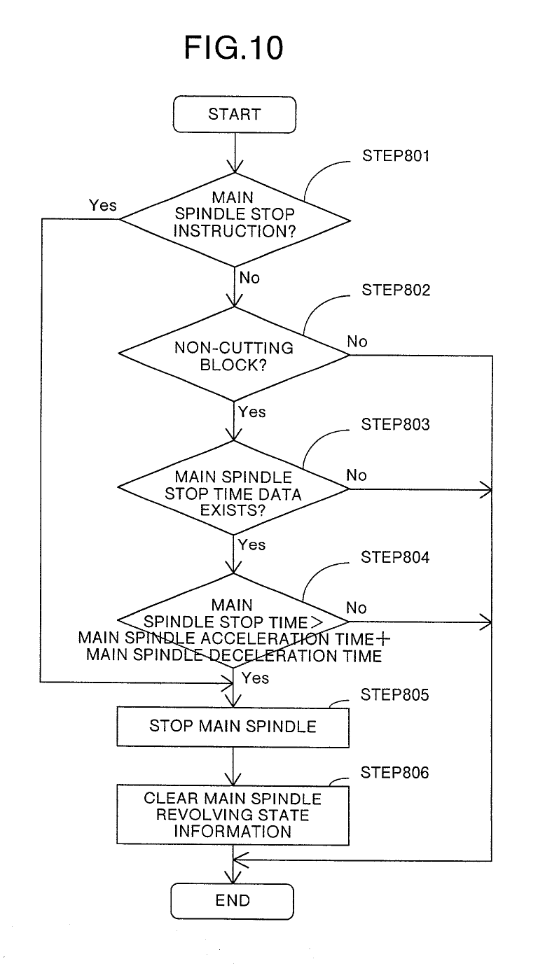

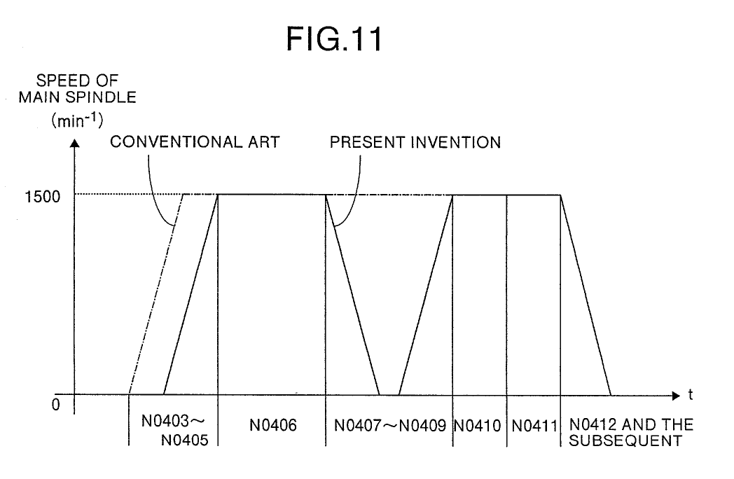

The second embodiment is directed to suppress unnecessary power consumption associated with revolution of the main spindle when a main spindle start instruction is given and in a period between cutting operations in the case where a machining program such as the machining program B is supplied. FIG. 7 is a block diagram showing the configuration of a numerically controlled apparatus according to the second embodiment of the invention. FIG. 8 is a flowchart showing the procedure of a program pre-reading and analyzing unit according to the second embodiment of the invention. FIG. 9 is a flowchart showing the procedure of a main spindle start timing calculating unit. FIG. 10 is a flowchart showing the procedure of a main spindle stop timing calculating unit according to the second embodiment of the invention. FIG. 11 is an explanatory diagram showing a change in the speed of the main spindle according to the second embodiment of the invention.

In FIG. 7, 61 denotes a program pre-reading and analyzing unit which preliminarily reads a block preceding a block being processed at present by one or more blocks from a machining program, analyzes the read block and stores the result of analysis to the prefetch buffer 2. In the prefetch buffer 2, information such as modal information of each block, shift amount of each axis, the instructed speed of the main spindle, feed speed, and main spindle start timing information is stored. 3 denotes an interpolating unit activated every predetermined sampling cycle (for example, 10 ms), which reads block information to be processed at present from the prefetch buffer 2 and executes an interpolating process. The result of interpolation is accelerated or decelerated by an accelerating/decelerating unit 4, and the resultant is output via a position data outputting unit 5 to a servo amplifier. The interpolating unit 3, an accelerating/decelerating unit 4, and a position data outputting unit 5 are units conventionally used.

63 indicates a main spindle start timing calculating unit which determines a timing to start the main spindle on the basis of time between the main spindle revolution instruction to the start of cutting operation, the speed of the main spindle at the start of cutting, main spindle acceleration time, and the like stored in the prefetch buffer 2 and read by the interpolating unit 3. When the main spindle is started, the main spindle start timing calculating unit 63 outputs a start signal. 8 indicates a speed data output unit which supplies an instruction of the speed of the main spindle to a main spindle amplifier. 64 denotes a main spindle acceleration/deceleration time estimating unit which estimates time required to accelerate or decelerate the main spindle to the instructed speed. To simplify calculation of the main spindle acceleration/deceleration time, in a manner similar to the main spindle acceleration time estimating unit 9 described in the first embodiment, an acceleration curve of the main spindle is approximated by a plurality of straight lines, and the main spindle acceleration time is obtained on the basis of the equation of the straight line. A deceleration curve of the main spindle is also approximated by a plurality of straight lines and main spindle deceleration time is obtained on the basis of an equation of the straight line. There is also a case such that the acceleration curve of the main spindle is approximated by a plurality of straight lines, main spindle acceleration time is obtained on the basis of an equation of the straight line, and calculation is executed by, main spindle acceleration time+main spindle acceleration time=acceleration/deceleration time or the acceleration/deceleration time is estimated on the basis of equations of the acceleration/deceleration curves of the main spindle.

62 denotes a main spindle stop timing calculating unit which determines whether the main spindle is stopped during revolution of the main spindle or not. As start conditions of a main spindle start timing calculating unit 63 and the main spindle stop timing calculating unit 62, when the main spindle is in a stopped state, the main spindle start timing calculating unit 63 is started. When the main spindle is revolving, the main spindle stop timing calculating unit 62 is started.

The detailed operations of the program pre-reading and analyzing unit 61 will now be described with reference to FIG. 8.

First, one block is read from the machining program at step 71 and analyzed at step 72. At step 73, whether the main spindle is revolving in the present block or not is determined. If Yes, the routine advances to step 82. If No, the routine advances to step 74. Whether the main spindle is revolving or not is determined on the basis of main spindle revolving state information to be set at step 75 and cleared at steps 91 and 92. Specifically, when the main spindle revolving state information is set, it is determined that the main spindle is revolving. When the main spindle revolving state information is cleared, it is determined that the main spindle is being stopped. At step 74, the analyzed block includes the main spindle revolution instruction or not is determined. If No, the analysis is finished. If Yes, the routine advances to step 75 where the main spindle revolving state information is set.

With respect to the main spindle revolution instruction, generally, M3 denotes forward revolution and M4 denotes reverse revolution. In the above-described machining program B, M3 in the N0403 block denotes the main spindle revolution instruction.

At step 76, data of time up to start of cutting operation which will be calculated later is initialized.

At step 77, whether there is the following block in the machining program or not is determined. When there is no following block, the analysis is finished. When there is the following block, at step 78, the following block is read in a manner similar to step 71. At step 79, one block is analyzed in a manner similar to step 72. Whether the analyzed block includes the main spindle stop instruction or not is determined at step 80. If Yes, at step 91, the main spindle revolving state information is cleared and the analysis is finished. As the main spindle stop instruction, generally, M5 is used. In the machining program B, M5 in the N0412 block corresponds to the main spindle stop instruction.

If No, whether the process is feed for cutting or not is determined at step 81. If No, the routine advances to step 82. If Yes, the analysis is finished. At step 82, execution time of the block is calculated and stored in the prefetch buffer 2. After that, steps 77 to 82 are repeatedly executed and block execution time is accumulated.

In the machining program B, the time since the main spindle revolution instruction is given in N0403 up to time before the cutting operation is started in N0406, that is, up to positioning time of N0405 is stored as block execution time.

On the other hand, at step 83, whether the analyzed block is a block of operation other than cutting operation (hereinbelow, called non-cutting block) such as a block of fast feed or not is determined. If the analyzed block is not the non-cutting block, the analysis is finished. It indicates that, since the main spindle is revolving and the cutting blocks are continued, the main spindle is allowed to remain revolving. When the analyzed block is the non-cutting block, the main spindle stop time is initialized at step 84. This process corresponds to N0407 and the like in the machining program B. At step 85, whether there is the following block or not is determined. If Yes, the routine advances to step 86. If No, the analysis is finished. At steps 86 and 87, in a manner similar to steps 71 and 72, one-block reading and one-block analyzing process is performed. At step 88, whether the main spindle stop instruction (generally MS) is included or not is determined. If the main spindle stop instruction is included, the main spindle revolving-state information is cleared at step 92, further, the main spindle stop time is cleared at step 93, and the analysis is finished. If the main spindle stop instruction is not included, the routine advances to step 89. At step 89, whether the analyzed block relates to feed for cutting or not is determined. If No, the routine advances to step 90. If Yes, the analysis is finished. At step 90, the execution time of the block and the main spindle stop time are stored as block execution time in the prefetch buffer 2. Subsequently, steps 85 to 90 are repeatedly executed and the main spindle stop time is accumulated.

In the machining program B, the execution time of the blocks N0407, N0408, and N0409 is stored as the main spindle stop time. That is, the main spindle stop time is equal to the execution time of blocks other than the cutting blocks, such as a block of fast feed sandwiched by the cutting blocks in which the main spindle is revolving.

The detailed operation of the main spindle start timing calculating unit 63 will now be described with reference to FIG. 9.

By the time the process is started for the first time, block execution time (A) shown in FIG. 9 is initialized (cleared to 0) and stored in a memory (not shown) in the numerical controlled apparatus according to the invention.

First, at step 41, whether the process is the first one or not is determined. In this case, when the block execution time (A) is “0”, the process is determined as the first process. When the block execution time (A) is not “0”, the process is determined as a second process or any of the subsequent processes.

When the process is the first process, at step 42, the block execution time stored in the block information being processed at present in the prefetch buffer 2 is read and stored as the block execution time (A).

The block process time herein indicates the block execution time calculated and accumulated at step 82 in FIG. 8 by the program pre-reading and analyzing unit 61.

At step 43, Ta(=block execution time (A)−main spindle acceleration time (acceleration time which is required to make the speed of the main spindle at the time of start reach the speed of the main spindle according to the main spindle revolution instruction) is obtained. The acceleration time of the main spindle is estimated by a method similar to that described in the first embodiment by the main spindle acceleration/deceleration time estimating unit 63.

At step 44, whether Ta is equal to or smaller than 0 is determined. If No, at step 45, interpolation time is subtracted from the block execution time (A) and the resultant is stored as new block execution time (A) in the memory and the routine returns to step 41. In the second and subsequent times, since the data of the block execution time (A) stored at step 45 is already stored in the memory and the block execution time (A) is not “0”, the process is determined as a process of second or later process at step 41. On the basis of this data, step 43 and subsequent steps are executed.

When Ta is 0 or smaller at step 44, at step 46A, the speed data outputting unit 8 is started to start the main spindle. Since the main spindle reaches the instructed speed with certain acceleration time, the main spindle reaches the instructed number speed of the main spindle just at the start of the cutting feed block.

Finally, at step 47, the block execution time (A) is cleared to “0”, thereby finishing the process.

The main spindle start timing calculating unit 63 is periodically activated in predetermined sampling cycles and the above processes are repeated.

In the second embodiment, the block execution time is calculated by the program pre-reading and analyzing unit 61. In the second embodiment as well, in a manner similar to the first embodiment, in place of the execution time, a value obtained by dividing the execution time by the sampling cycle of the main spindle start timing calculating unit 63, that is, the number of sampling times of the main spindle start timing calculating unit 63 may be used. For example, when it is assumed that the execution time is 300 ms and the sampling cycle of the main spindle start timing calculating unit 63 is 10 ms, the number of sampling times becomes (300/10=) 30 times. Further, when each of all the data indicative of time such as the main spindle acceleration time, block execution time (A), and interpolation time shown in FIG. 9 is converted to the number of sampling times of the main spindle start timing calculating unit 63 and the resultant replaces corresponding data in FIG. 9, for example, “subtraction of the interpolation time” at step 45 becomes subtraction of only “1” since the interpolation time is 10 ms, all of the calculations after the conversion of the number of sampling times become only a subtracting process using integers and no fractions. Therefore, the process becomes simpler and is dealt more easily in a software process.

Although a fraction may be generated at the time of conversion of the number of sampling times, in this case, a process of rounding up or off the fraction to an integer is performed.

The detailed operation of the main spindle stop timing calculating unit 62 will now be described by referring to FIG. 10.

First, at step 801, whether the main spindle stop instruction is included in a block being executed at present or not is determined. If Yes, the main spindle is stopped at step 806, thereby finishing the process.

If No, at step 802, whether the block being executed at present is a non-cutting block or not is determined. When it is not a not-cutting block, that is, the cutting block, the process is finished and the main spindle is allowed to remain revolving. When it is the non-cutting block, the routine advances to step 803 where whether there is main spindle stop time data or not is determined. The main spindle stop time is time calculated at step 90 in FIG. 8. When the feed for cutting is temporarily interrupted by positioning or the like during revolution of the main spindle, the interrupted time is stored. When there is no main spindle stop time data, it indicates that the feed for cutting continues or the main spindle does not revolve, so that it is unnecessary to perform the main spindle stop control. Consequently, when there is no main spindle stop time data at step 803 (that is, when the main spindle stop time is 0), the process is finished without performing anything.

When the main spindle stop time data is stored at step 803, the routine advances to step 804. At step 804, the main spindle stop time and main spindle acceleration/deceleration time (=main spindle acceleration time+main spindle deceleration time) computed by the main spindle acceleration/deceleration time estimating unit 64 are compared with each other. If the main spindle stop time is longer than the main spindle acceleration time, the main spindle is stopped at step 805. Further, at step 806, main spindle revolving state information stored at step 75 in FIG. 8 is cleared and the process is finished. If it is determined at step 804 that the main spindle stop time is equal to or shorter than the main spindle acceleration/deceleration time, the process is finished without stopping the main spindle.

Also in FIG. 10, in place of each of the main spindle stop time and the main spindle acceleration/deceleration time, the value obtained by dividing each of the main spindle stop time and the main spindle acceleration/deceleration time by the sampling cycle of the main spindle stop timing calculating unit 62, that is, the number of sampling times of the main spindle stop timing calculating unit 62 may be used.

FIG. 11 is an explanatory diagram showing a change in the speed of the main spindle in the case of controlling the speed of the main spindle as described above. As obvious from the drawing, conventionally, the main spindle continuously revolves during the period since the main spindle revolution instruction is given until the main spindle stop instruction is given. However, in the second embodiment, the timing at which the main spindle is actually started after the main spindle revolution instruction is given is controlled so as to reach the instructed speed just when the cutting operation is started. When the cutting instruction is interrupted during the revolution of the main spindle, the revolution of the main spindle is temporarily stopped and the main spindle is controlled so as to reach the instruction speed again at the timing at which the cutting operation is started next time.

Consequently, in blocks of positioning and the like which do not contribute to machining, the main spindle does not revolve, so that power is not consumed uselessly.

In the second embodiment, the case of calculating the execution time since the main spindle revolution instruction is given until the feed for cutting is started by the program pre-reading and analyzing unit 61 has been described. The initial object can be also achieved by means other than the program pre-reading and analyzing unit 61.

In the second embodiment, to maximally reduce the power consumption by the main spindle revolution instruction, after elapse of time obtained by subtracting the main spindle acceleration time required to reach the speed of the main spindle according to the main spindle revolution instruction from the start of the main spindle from the execution time since the main spindle revolution instruction is given until the feed for cutting is started since the main spindle revolution instruction, the main spindle is started. Alternately, the initial object can be also achieved by starting the main spindle after elapse of predetermined time before the subtracted time.

Obviously, the second embodiment can be used in combination with the first embodiment.

As described above, according to the invention, a block preceding the present block by one or more blocks is read and analyzed and, on the basis of the result of the pre-reading and analyzing the block, the timing of starting the peripheral speed constant function is controlled. Therefore, when a predetermined condition is satisfied, a control in which the peripheral speed constant control is not performed during the period since the peripheral speed constant instruction is given until the predetermined time is elapsed can be performed. Thus, an effect such that the unnecessary power consumption by the peripheral speed uniforming control can be reduced is produced.

According to the invention, after the time obtained by subtracting the main spindle reach time required to make the speed of the main spindle before the peripheral speed uniforming instruction reach the speed of the main spindle at the start of cutting operation according to the peripheral speed uniforming instruction from the execution time elapses since the peripheral speed uniforming instruction, the peripheral speed uniforming control function is started, so that the main spindle can reach the instructed peripheral speed just at the start of cutting. Thus, an effect such that the power consumption can be maximally reduced without hindering the cutting is produced.

According to the invention, each of the execution time since the peripheral speed uniforming instruction is given until feed for cutting is started and the main spindle reach time required to make the speed of the main spindle before the peripheral speed uniforming instruction reach the speed of the main speed according to the peripheral speed uniforming instruction (or the main spindle reach time required to make the speed of the main spindle before the peripheral speed uniforming instruction reach the speed of the main spindle at the start of cutting according to the peripheral speed uniforming instruction) is converted to the number of sampling times of software and the obtained number of sampling times is used. Consequently, a software process is facilitated and an effect such that a burden on the CPU is lessened is produced.

According to the invention, the acceleration curve or a deceleration curve of the main spindle is approximated by a plurality of straight lines, and the main spindle reach time is estimated on the basis of an equation of the straight line. Thus, an effect such that the main spindle reach time up to an arbitrary speed of the main spindle can be derived by a simple equation and the burden on the CPU can be accordingly lessened is produced.

According to the invention, a block preceding a present block by one or more blocks is preliminarily read and analyzed and, on the basis of the result of pre-reading and analysis, a timing of starting the main spindle is controlled. Therefore, when a predetermined condition is satisfied, the main spindle can be controlled so as to be stopped until predetermined time elapses since the main spindle revolution instruction is given. Thus, an effect such that consumption of power wasted by revolving the main spindle in the non-cutting blocks can be reduced is obtained.

According to the invention, the main spindle is started after time obtained by subtracting the main spindle acceleration time required to reach the speed of the main spindle according to the main spindle revolution instruction from the start of the main spindle from the execution time since the main spindle revolution instruction is given until feed for cutting is started elapses since the main spindle revolution instruction. Consequently, the main spindle can reach the instructed speed just at the start of cutting. Thus, an effect such that the power consumption can be maximally reduced without hindering the cutting is produced.

According to the invention, each of the execution time since the peripheral speed uniforming instruction is given until feed for cutting is started and the main spindle reach time required to reach the speed of the main speed according to the peripheral speed uniforming instruction from the start of the main spindle is converted to the number of sampling times of software and the obtained number of sampling times is used. Consequently, a software process is facilitated and an effect such that a burden on the CPU is lessened is produced.

According to the invention, the acceleration curve or a deceleration curve of the main spindle is approximated by a plurality of straight lines, and the main spindle acceleration time is estimated on the basis of an equation of the straight line. Thus, an effect such that the main spindle reach time up to an arbitrary speed of the main spindle can be derived by a simple equation and the burden on the CPU can be accordingly lessened is produced.

According to the invention, when a predetermined condition is satisfied, the main spindle is stopped even during a main spindle revolution instruction. Thus, an effect such that the power consumption can be reduced without unnecessarily revolting the main spindle is achieved.

According to the invention, when the present block becomes a block which is not a non-cutting block during the revolution of the main spindle, the time until the cutting is started next, that is, the main spindle stop time with the acceleration/deceleration time of the main spindle. When the main spindle acceleration/deceleration time is longer, the main spindle is not stopped. Consequently, the main spindle is not unnecessarily revolved and the power consumption can be reduced. Moreover, the cycle time is not extended by waiting for reach of the speed of the main spindle at the start of cutting. Thus, an effect such that an optimum main spindle control can be performed is produced.

According to the invention, an acceleration curve or a deceleration curve of the main spindle is approximated by a plurality of straight lines, and the acceleration/deceleration time of the main spindle is estimated on the basis of an equation of the straight line. Thus, an effect such that the acceleration/deceleration time to an arbitrary main spindle speed can be derived by a simple equation and the burden on the CPU can be lessened is produced.

According to the invention, a block preceding a present block by one or more blocks is preliminarily read and analyzed and, on the basis of the result of the pre-reading and analysis, a timing of starting the peripheral speed uniforming control function is controlled. Consequently, when a predetermined condition is satisfied, the control which does not perform the peripheral speed uniforming control until predetermined time elapses since the peripheral speed uniforming instruction is given can be performed. Since the timing of starting the main spindle is controlled on the basis of the result of the pre-reading and analysis, when a predetermined condition is satisfied, the main spindle can be controlled so as to be stopped until predetermined time elapses since the peripheral speed uniforming instruction is given. Thus, an effect such that unnecessary power consumption by executing the peripheral speed uniforming control and unnecessary power consumption by revolving the main spindle in the non-cutting blocks can be reduced is obtained.

According to the invention, the peripheral speed uniforming control function is started after elapse of time obtained by subtracting the main spindle reach time required to reach the main spindle speed at the start of cutting according to the peripheral speed uniforming instruction from the main spindle speed before the peripheral speed uniforming instruction from the execution time since the peripheral speed uniforming instruction is given until the feed for cutting is started since the peripheral speed uniforming instruction, so that the main spindle can reach the instructed speed just at the start of cutting. Also, the main spindle is started after time obtained by subtracting the main spindle acceleration time required to reach the main spindle speed according to the main spindle speed instruction from the start of the main spindle from the execution time since the main spindle revolution instruction is given until the feed for cutting is started elapses since the main spindle revolution instruction. Consequently, the main spindle can reach the instructed speed just at the start of cutting. Thus, an effect such that the power consumption can be maximally reduced without hindering the cutting is obtained.

According to the invention, a block preceding a present block by one or more blocks is preliminarily read and analyzed and, on the basis of the result of the pre-reading and analysis, the timing of starting the peripheral speed uniforming control function is started. Therefore, when a predetermined condition is satisfied, a control in which the peripheral speed uniforming control is not performed until predetermined time elapses since the peripheral speed uniforming instruction is given can be performed. When a predetermined condition is satisfied, the main spindle is stopped. Thus, the main spindle is not unnecessarily revolted, and an effect such that consumption of power can be reduced is obtained.

According to the invention, the peripheral speed uniforming control function is started after time obtained by subtracting the main spindle reach time required to make the speed of the main spindle before the peripheral speed uniforming instruction reach the speed of the main spindle at the start of cutting according to the main spindle revolution instruction from the execution time since the main spindle revolution instruction is given until feed for cutting is started elapses since the main spindle revolution instruction. When a present block becomes a block which is not the non-cutting block during the main spindle revolution, time until the cutting is started next, that is, the main spindle stop time is compared with the main spindle acceleration/deceleration time. When the main spindle acceleration/deceleration time is longer, the main spindle is not stopped. Thus, an effect such that the power consumption can be maximally reduced without hindering the cutting is produced, moreover, the cycle time is not extended by waiting for reach of the speed of the main spindle at the start of cutting, and an optimum main spindle control can be performed is produced.

According to the invention, on the basis of the result of the pre-reading and analysis, the timing of starting the main spindle is controlled. When a predetermined condition is satisfied, the main spindle can be controlled so as to be stopped until predetermined time elapses since the main spindle speed instruction is given. Also, when a predetermined condition is satisfied, the main spindle is stopped during the revolution of the main spindle. Therefore, an effect such that the main spindle is not revolved unnecessarily and power consumption can be reduced is produced.

According to the invention, the main spindle is started after elapse of time obtained by subtracting the main spindle acceleration time required to reach the main spindle speed according to the main spindle revolution instruction from the start of the main spindle from the execution time since the main spindle revolution instruction is given to the start of feed for cutting since the main spindle revolution instruction. Consequently, the main spindle can reach the instructed speed just at the start of cutting. When a present block becomes a block which is not the non-cutting block during the main spindle revolution, the time until the cutting is started next, that is, the main spindle stop time is compared with the main spindle acceleration/deceleration time. When the main spindle acceleration/deceleration time is longer, the main spindle is not stopped. Consequently, without hindering the cutting operation, the power consumption can be maximally reduced and, moreover, the cycle time is not extended by waiting for reach of the speed of the main spindle at the start of cutting. An effect such that the optimum main spindle control can be performed is obtained.

Industrial Applicability

As described above, the numerical control method and numerically controlled apparatus according to the invention are suitable to be used in a numerically controlled apparatus having the peripheral speed uniforming control function or the like.

1. A numerical control method of controlling a numerically controlled apparatus having a peripheral speed uniforming control function for controlling speed of a main spindle so that a peripheral speed becomes constant in accordance with a change in position of a reference axis during feed for cutting, comprising the steps of: preliminarily reading and analyzing a block preceding a present block by one or more blocks; and, on the basis of a result of the pre-reading and analysis, controlling a timing of starting the peripheral speed uniforming control function.

2. A numerical control method of controlling a numerically controlled apparatus having a peripheral speed uniforming control function for controlling speed of a main spindle so that a peripheral speed becomes constant in accordance with a change in position of a reference axis during feed for cutting, comprising the steps of: preliminarily reading and analyzing a block preceding a present block by one or more blocks, on the basis of a result of the pre-reading and analysis; obtaining execution time since a peripheral speed uniforming instruction is given until feed for cutting is started and main spindle reach time required to make the speed of the main spindle before the peripheral speed uniforming instruction reach the speed of the main spindle according to the peripheral speed uniforming instruction; and controlling a timing of starting the peripheral speed uniforming control function on the basis of the execution time and the main spindle reach time obtained.

3. A numerically controlled apparatus having a peripheral speed uniforming control function for controlling speed of a main spindle so that a peripheral speed becomes constant in accordance with a change in position of a reference axis during feed for cutting, comprising:
a program pre-reading and analyzing unit which preliminarily reads and analyzes a block preceding a present block by one or more blocks; and
a peripheral speed uniforming control function start timing calculating unit which controls a timing of starting the peripheral speed uniforming control function on the basis of a result of the pre-reading and analysis of the program pre-reading and analyzing unit.

4. A numerically controlled apparatus having a peripheral speed uniforming control function for controlling speed of a main spindle so that a peripheral speed becomes constant in accordance with a change in position of a reference axis during feed for cutting, comprising:
a program pre-reading and analyzing unit which pre-reads and analyzes a block preceding a present block by one or more blocks;
a unit which obtains execution time since a peripheral speed uniforming instruction is given until feed for cutting is started and main spindle reach time required to make the speed of the main spindle before the peripheral speed uniforming instruction reach the speed of the main spindle according to the peripheral speed uniforming instruction on the basis of a result of the pre-reading and analysis of the program pre-reading and analyzing unit; and
a peripheral speed uniforming control function start timing calculating unit which controls a timing of starting the peripheral speed uniforming control function on the basis of the execution time and the main spindle reach time obtained by the unit.

5. The numerically controlled apparatus according to claim 4, wherein the peripheral speed uniforming control function start timing calculating unit starts the peripheral speed uniforming control function after time obtained by subtracting the main spindle reach time required to make the speed of the main spindle before the peripheral speed uniforming instruction reach the speed of the main spindle at the start of cutting operation according to the peripheral speed uniforming instruction from the execution time elapses since the peripheral speed uniforming instruction.

6. The numerically controlled apparatus according to claim 4 or 5, wherein each of the execution time and main spindle reach time is converted to the number of sampling times of software and the obtained number of sampling times is used.

7. The numerically controlled apparatus according to claim 4, wherein an acceleration curve or a deceleration curve of the main spindle is approximated by a plurality of straight lines, and the main spindle reach time is estimated on the basis of an equation of the straight line.

8. A numerical control method of controlling a numerically controlled apparatus having a function of controlling the speed of a main spindle, comprising the steps of:
preliminarily reading and analyzing a block preceding a present block by one or more blocks; and
controlling a timing of starting the main spindle on the basis of a result of the pre-reading and analysis.

9. A numerical control method of controlling a numerically controlled apparatus having a function of controlling the speed of a main spindle, comprising the steps of:
preliminarily reading and analyzing a block preceding a present block by one or more blocks;
on the basis of a result of the pre-reading and analysis, obtaining execution time since a peripheral speed uniforming instruction is given until feed for cutting is started and main spindle reach time required to reach the speed of the main spindle according to the peripheral speed uniforming instruction from start of the main spindle; and
controlling a timing of starting the main spindle on the basis of the execution time and the main spindle reach time obtained.

10. A numerically controlled apparatus having a function of controlling speed of a main spindle, comprising:
a program pre-reading and analyzing unit which preliminarily reads and analyzes a block preceding a present block by one or more blocks; and
a main spindle start timing calculating unit which controls a timing of starting the main spindle on the basis of a result of the pre-reading and analysis of the program pre-reading and analyzing unit.

11. A numerically controlled apparatus having a function of controlling speed of a main spindle, comprising:
a program pre-reading and analyzing unit which pre-reads and analyzes a block preceding a present block by one or more blocks;
a unit which obtains execution time since a main spindle revolution instruction is given until feed for cutting is started and main spindle acceleration time required to reach the speed of the main spindle according to the main spindle revolution instruction from start of the main spindle on the basis of a result of the pre-reading and analysis of the program pre-reading and analyzing unit; and
a main spindle start timing calculating unit which controls a timing of starting the main spindle on the basis of the execution time and the main spindle acceleration time obtained by the unit.

12. The numerically controlled apparatus according to claim 11, wherein the main spindle start timing calculating unit starts the main spindle after time obtained by subtracting the main spindle acceleration time from the execution time elapses since the main spindle revolution instruction.

13. The numerically controlled apparatus according to claim 11 or 12, wherein each of the execution time and main spindle acceleration time is converted to the number of sampling times of software and the obtained number of sampling times is used.

14. The numerically controlled apparatus according to claim 11, wherein an acceleration curve or a deceleration curve of the main spindle is approximated by a plurality of straight lines, and the main spindle acceleration time is estimated on the basis of an equation of the straight line.

15. A numerical control method of controlling a numerically controlled apparatus having a function of controlling speed of a main spindle, comprising the steps of: preliminarily reading and analyzing a block preceding a present block by one or more blocks; and when a result of the pre-reading and analysis satisfies a predetermined condition, stopping the main spindle even during a main spindle revolution instruction.

16. A numerical control method of controlling a numerically controlled apparatus having a function of controlling speed of a main spindle, comprising the steps of:
preliminarily reading and analyzing a block preceding a present block by one or more blocks;
when a result of the pre-reading and analysis shows that it is during a main spindle revolution instruction and a non-cutting block exists, obtaining main spindle stop time between the non-cutting block and start of feed for cutting and acceleration/deceleration time of the main spindle on the basis of the result of the pre-reading and analysis;
comparing the main spindle stop time obtained with the acceleration/deceleration time of the main spindle; and
stopping the main spindle even during the main spindle revolution instruction when the main spindle stop time is longer than the acceleration/deceleration time of said main spindle.

17. A numerically controlled apparatus having a function of controlling speed of a main spindle, comprising:
a program pre-reading and analyzing unit which pre-reads and analyzes a block preceding a present block by one or more blocks; and
a main spindle stop timing calculating unit which stops the main spindle even during a main spindle revolution instruction when a result of the pre-reading and analysis performed by the program pre-reading and analyzing unit satisfies a predetermined condition.

18. A numerically controlled apparatus having a function of controlling speed of a main spindle, comprising:
a program pre-reading and analyzing unit which preliminarily reads and analyzes a block preceding a present block by one or more blocks;
a unit which obtains main spindle stop time between a non-cutting block and start of feed for cutting and acceleration/deceleration time of the main spindle on the basis of the result of the pre-reading and analysis when a result of the pre-reading and analysis shows that it is during the main spindle revolution instruction and a non-cutting block exists; and
a main spindle stop timing calculating unit which compares said main spindle stop time with the acceleration/deceleration time of said main spindle obtained by the unit and, when the former is longer the latter, stops the main spindle even during the main spindle revolution instruction.

19. The numerically controlled apparatus according to claim 18, wherein an acceleration curve or a deceleration curve of the main spindle is approximated by a plurality of straight lines, and the acceleration/deceleration time of said main spindle is estimated on the basis of an equation of the straight line.

20. A numerical control method comprising the steps of preliminarily reading and analyzing a block preceding a present block by one or more blocks and controlling a timing of starting a peripheral speed uniforming control function and a timing of starting a main spindle on the basis of a result of the pre-reading and analysis.

21. A numerical control method comprising the steps of:
preliminarily reading and analyzing a block preceding a present block by one or more blocks;
on the basis of a result of the pre-reading and analysis, obtaining first execution time since a peripheral speed uniforming instruction is given until feed for cutting is started, main spindle reach time required to make speed of a main spindle before the peripheral speed uniforming instruction reach the speed of the main spindle at the start of cutting according to the peripheral speed uniforming instruction, second execution time since a main spindle revolution instruction is given until feed for cutting is started, and main spindle acceleration time since the main spindle is started until the speed of the main spindle at the start of cutting according to the main spindle revolution instruction is reached; and
starting the peripheral speed uniforming control function after elapse of time obtained by subtracting the main spindle reach time from the first execution time since the peripheral speed uniforming instruction, and starting said main spindle after time obtained by subtracting the main spindle acceleration time from the second execution time elapses since the main spindle revolution instruction.

22. A numerically controlled apparatus comprising:
a program pre-reading and analyzing unit which preliminarily reads and analyzes a block preceding a present block by one or more blocks;
a peripheral speed uniforming control function start timing calculating unit which controls a timing of starting a peripheral speed uniforming control function on the basis of a result of the pre-reading and analysis of the program pre-reading and analyzing unit; and
a main spindle start timing calculating unit which controls a timing of starting the main spindle on the basis of a result of pre-reading and analysis of the program pre-reading and analyzing unit.

23. A numerically controlled apparatus comprising:
a program pre-reading and analyzing unit which preliminarily reads and analyzes a block preceding a present block by one or more blocks;
a unit which obtains, on the basis of a result of pre-reading and analysis of the program pre-reading and analyzing unit, first execution time since a peripheral speed uniforming instruction is given until feed for cutting is started, main spindle reach time required to make speed of a main spindle before the peripheral speed uniforming instruction reach the speed of the main spindle at the start of cutting according to the peripheral speed uniforming instruction, second execution time since a main spindle revolution instruction is given until feed for cutting is started, and main spindle acceleration time required to reach the speed of the main spindle according to the main spindle revolution instruction from start of the main spindle;
a peripheral speed uniforming control function start timing calculating unit which starts the peripheral speed uniforming control function after elapse of time obtained by subtracting the main spindle reach time from the first execution time since the peripheral speed uniforming instruction; and
a main spindle start timing calculating unit which starts the main spindle after time obtained by subtracting the main spindle acceleration time from the second execution time elapses since the main spindle revolution instruction.

24. A numerical control method comprising the steps of:
preliminarily reading and analyzing a block preceding a present block by one or more blocks;
controlling a timing of starting a peripheral speed uniforming control function on the basis of a result of the pre-reading and analysis; and
stopping a main spindle even during a main spindle revolution instruction when the result of pre-reading and analysis satisfies a predetermined condition.

25. A numerical control method comprising the steps of:
preliminarily reading a block preceding a present block by one or more blocks;
on the basis of a result of the pre-reading and analysis, obtaining first execution time since a peripheral speed uniforming instruction is given until feed for cutting is started and main spindle reach time required to make speed of a main spindle before the peripheral speed uniforming instruction reach the speed of the main spindle at the start of cutting operation according to the peripheral speed uniforming instruction;
when a result of the pre-reading and analysis shows that it is during the main spindle revolution instruction and a non-cutting block exists, on the basis of a result of the pre-reading and analysis, obtaining main spindle stop time between the non-cutting block and start of feed for cutting and acceleration/deceleration time of the main spindle;
starting the peripheral speed uniforming control function after time obtained by subtracting the main spindle reach time from the first execution time elapses since the peripheral speed uniforming instruction;
comparing the main spindle stop time with the acceleration/deceleration time of the main spindle; and
when the main spindle stop time is longer than the acceleration/deceleration time of the main spindle, stopping the main spindle even during the main spindle revolution instruction.

26. A numerically controlled apparatus comprising:
a program pre-reading and analyzing unit which preliminarily reads and analyzes a block preceding a present block by one or more blocks;
a peripheral speed uniforming control function start timing calculating unit which controls a timing of starting a peripheral speed uniforming control function on the basis of a result pre-reading and analysis of the program pre-reading and analyzing unit; and
a main spindle stop timing calculating unit which stops a main spindle even during a main spindle resolution instruction when the result of pre-reading and analysis of the program pre-reading and analysis unit satisfies a predetermined condition.

27. A numerically controlled apparatus comprising:
a program pre-reading and analyzing unit which preliminarily reads and analyzes a block preceding a present block by one or more blocks;
a unit which obtains, on the basis of a result of pre-reading and analysis of the program pre-reading and analyzing unit, first execution time since a peripheral speed uniforming instruction is given until feed for cutting is started and main spindle reach time required to make speed of a main spindle before the peripheral speed uniforming instruction reach the speed of the main spindle at the start of cutting according to the peripheral speed uniforming instruction;
a unit which obtains main spindle stop time between a non-cutting block and start of feed for cutting and acceleration/deceleration time of the main spindle on the basis of a result of the pre-reading and analysis of the program pre-reading and analyzing unit when the result of the pre-reading and analysis shows that it is during a main spindle revolution instruction and the non-cutting block exists;
a peripheral speed uniforming control function start timing calculating unit which starts the peripheral speed uniforming control function after elapse of time obtained by subtracting the main spindle reach time from the first execution time since the peripheral speed uniforming instruction; and
a main spindle stop timing calculating unit which compares the main spindle stop time and the acceleration/deceleration time of the main spindle obtained by the unit with each other and, when the former is longer than the latter, stops the main spindle even in the main spindle revolution instruction.

28. A numerical control method comprising the steps of:
preliminarily reading and analyzing a block preceding a present block by one or more blocks;
controlling a timing of starting a main spindle on the basis of a result of the pre-reading and analysis; and
stopping the main spindle even during a main spindle revolution instruction when the result of pre-reading and analysis satisfies a predetermined condition.

29. A numerical control method comprising the steps of:
preliminarily reading a block preceding a present block by one or more blocks;
on the basis of a result of the pre-reading and analysis, obtaining second execution time since a main spindle instruction is given until feed for cutting is started and main spindle acceleration time since start of the main spindle until speed of the main spindle according to the main spindle revolution instruction is reached;
when the result of the pre-reading and analysis shows that it is during the main spindle revolution instruction and a non-cutting block exists, on the basis of the result of the pre-reading and analysis, obtaining main spindle stop time between the non-cutting block and start of feed for cutting and acceleration/deceleration time of the main spindle;
starting the main spindle after time obtained by subtracting the acceleration time of the main spindle from the second execution time elapses since the main spindle revolution instruction;
comparing the main spindle stop time with the acceleration/deceleration time of the main spindle; and
when the main spindle stop time is longer than the acceleration/deceleration time of the main spindle, stopping the main spindle even during the main spindle revolution instruction.

30. A numerically controlled apparatus comprising:
a program pre-reading and analyzing unit which preliminarily reads and analyzes a block preceding a present block by one or more blocks;
a main spindle start timing calculating unit which controls a timing of starting a main spindle on the basis of a result of pre-reading and analysis of the program pre-reading and analyzing unit; and
a main spindle stop timing calculating unit which stops a main spindle even during a main spindle resolution instruction when the result of pre-reading and analysis of the program pre-reading and analysis unit satisfies a predetermined condition.

31. A numerically controlled apparatus comprising:
a program pre-reading and analyzing unit which preliminarily reads and analyzes a block preceding a present block by one or more block;
a unit which obtains, on the basis of a result of pre-reading and analysis of the program pre-reading and analyzing unit, second execution time since a peripheral speed uniforming instruction is given until feed for cutting is started and main spindle acceleration time since the main spindle is started until speed of the main spindle according to the main spindle revolution instruction is reached;
a unit, when a result of the pre-reading and analysis shows that it is during the main spindle revolution instruction and a non-cutting block exists, for obtaining main spindle stop time between the non-cutting block and start of feed for cutting and acceleration/deceleration time of the main spindle on the basis of the result of the pre-reading and analysis;
a main spindle start timing calculating unit which starts the main spindle after elapse of time obtained by subtracting the main spindle acceleration time from the second execution time since the main spindle resolution instruction; and
a main spindle stop timing calculating unit which compares the main spindle stop time and the acceleration/deceleration time of the main spindle obtained by the unit and, when the former is longer than the latter, stops the main spindle even during the main spindle revolution instruction.
